(19) United States
(12) Patent Application Publication
(10) Pub. No.: US 2013/0063238 A1
(43) Pub. Date: Mar. 14, 2013

(54) CHIP INDUCTOR

(71) Applicants: Bong Sup LIM, Busan (KR); Yong Sun Park, Gyeongsangnam-do (KR); Yong Un Choi, Busan (KR); Sung Jin Park, Busan (KR)

(72) Inventors: Bong Sup LIM, Busan (KR); Yong Sun Park, Gyeongsangnam-do (KR); Yong Un Choi, Busan (KR); Sung Jin Park, Busan (KR)

(73) Assignee: SAMSUNG ELECTRO-MECHANICS CO., LTD.

(21) Appl. No.: 13/589,659

(22) Filed: Aug. 20, 2012

(30) Foreign Application Priority Data
Sep. 8, 2011 (KR) 10-2011-0091430

(51) Int. Cl. H01F 5/00

(52) U.S. Cl. 336/200

(57) ABSTRACT

Disclosed herein is a laminated chip inductor including: a laminate including a plurality of first sheets having conductive patterns printed thereon and laminated in order; and a sheet having a discrimination via hole and provided on and/or under the laminate.

### CROSS REFERENCE(S) TO RELATED APPLICATIONS

This application claims the benefit under 35 U.S.C. Section 119 of Korean Patent Application Serial No. 10-2011-0091430, entitled “Chip Inductor” filed on Sep. 8, 2011, which is hereby incorporated by reference in its entirety into this application.

### BACKGROUND OF THE INVENTION

1. Technical Field

The present invention relates to a laminated chip inductor, and more particularly, to a laminated chip inductor constructed to be readily discriminated.

2. Description of the Related Art

An inductor that is one of components forming an electronic circuit, together with a resistor and a condenser, and in which a ferrite core is wound with coils or is printed to form electrodes at both ends thereof is used as a component reducing noise and forming an LC resonance circuit.

An inductor can be classified into various types, such as a laminated type, a wounded type and a thin film type, and a laminated inductor is commonly used to meet recent demands for miniaturization.

FIG. 1 is an exploded perspective view of a laminated chip inductor according to the related art.

With reference to FIG. 1, the laminated chip inductor 10 according to the related art has a laminate 12 including a plurality of first sheets having coil-shaped conductive patterns printed thereon.

Via holes (not shown) are formed at the end of the conductive patterns and the via holes are filled with conductive paste to electrically connect the conductive patterns of each layer, so that one coil may be formed.

The laminate 12 includes a second sheet 13 on which the conductive patterns are not printed and the second sheet 13 has a marked portion 14 marked on an upper end thereof.

The laminated chip inductor affects peripheral components when mounting a substrate according to a laminated direction of an internal circuit, but directionality of the inductor is distinguished by the marked portion 14, such that the inductor may be laminated in a certain direction when mounting the substrate. The marked portion 14 is confirmed by means of a visual device such as a CCD to thereby sort elements or evaluate characteristics thereof.

A manufacturing process of the laminated chip inductor will be briefly described as follows.

First, conductive patterns and via holes are formed on a wide ceramic sheet, such a plurality of sheets are repeatedly laminated, a discrimination sheet not printed with conductive patterns are again laminated, and a pressing process and a firing process are performed thereon. In addition, a marked portion for separately marking an appearance is printed on a sheet not printed with conductive patterns through a marking process. Thereafter, a laminated chip inductor to be required is manufactured through a cutting process for cutting the laminate into proper size and a polishing process for polishing sharp edges thereof.

As described above, the laminated chip inductor according to the related art requires a marking process for marking a marked portion and in the marking process, an extra screen for marking needs to be manufactured, thereby causing an increase in manufacturing costs.

When being applied to a micro laminated chip inductor, the recognition of the marking is significantly degraded.

The marked portion is damaged during the polishing process and the cutting process, thereby causing a difficulty in discrimination.

A material of the inductor is applied with stress due to a shrinkage difference between the material of the inductor and the marked portion, thereby causing a phenomenon that the laminate is bent.

### SUMMARY OF THE INVENTION

An object of the present invention is to provide a laminated chip inductor including sheets having via holes provided thereon.

According to an exemplary embodiment of the present invention, there is provided a chip inductor, including: a laminate including a plurality of first sheets having conductive patterns printed thereon and laminated in order; and a second sheet having a discrimination via hole and provided on and under the laminate.

A color of the second sheet may be different from that of the laminate.

The second sheet may be made of a different material from the laminate.

The discrimination via hole may have a circular shape or a square shape.

The number of the discrimination via hole may be at least one.

According to another exemplary embodiment of the present invention, there is provided a chip inductor including: a laminate having a plurality of first sheets printed with conductive patterns thereon and laminated in order; a second sheet having a discrimination via hole and provided on the laminate; and a third sheet having a discrimination via hole and provided under the laminate.

The second sheet and/or third sheet may have different colors from the laminate.

The second sheet and/or the third sheet may be made of a different material from the laminate.

The discrimination via hole may have a circular shape and a square shape.

The number of the discrimination via hole may be at least one.

### BRIEF DESCRIPTION OF THE DRAWINGS

FIG. 1 is an exploded perspective view of a laminated chip inductor according to the related art;

FIG. 2 is an exploded perspective view of a laminated chip inductor according to the present invention;

FIGS. 3A to 3D are illustrative views of modifying a second sheet that is a component of the laminated chip inductor according to the present invention into various shapes; and

FIG. 4 is an exploded perspective view of a laminated chip inductor according to another exemplary embodiment of the present invention.

### DESCRIPTION OF THE PREFERRED EMBODIMENTS

Hereinafter, exemplary embodiments of the present invention will be described in detail with reference to the accompanying drawings. The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

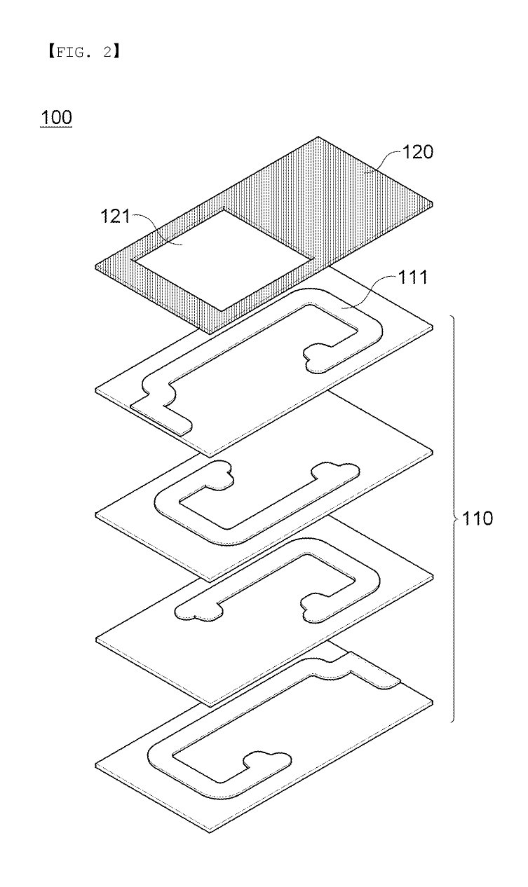

FIG. 2 is an exploded perspective view of a laminated chip inductor 100 according to the present invention.

With reference to FIG. 2, the laminated chip inductor 100 of the present invention may include a laminate 110 including a plurality of first sheets having coil-shaped conductive patterns 111 printed thereon and a second sheet 120 provided on the laminate 110 and having a discrimination via hole 121 discriminating elements.

Here, the second sheet 120 may be simultaneously laminated at the time of laminating the plurality of first sheets. The discrimination via hole 121 may be preferably formed in the process of forming via holes (not shown) for electrically connecting the conductive patterns 111 printed on the first sheets.

As described above, in the laminated chip inductor of the present invention, the second sheet 120 is laminated simultaneously with the laminating of the first sheets, thereby making it possible to prevent the chip from being bent due to a shrinkage error of the marked portion which may occur in the marking process for printing the marked portion according to the related art, and reduce production costs of the chip inductor due to unnecessity of the marking process for printing the marked portion.

The second sheet 120 may be preferably formed with a different color from the first sheets. The reason is that if the color of the first sheets is identical to that of the second sheet 120, it is difficult to distinguish between the first sheets and the second sheet 120 due to their same colors which can be recognized through the discrimination via hole 121. Therefore, the color of the second sheet 120 and the first sheets may be preferably configured to create complementary contrast.

These colors may be distinguished by adding a separate pigment at the time of manufacturing the sheets or allowing the second sheet 120 and the first sheets to have different materials.

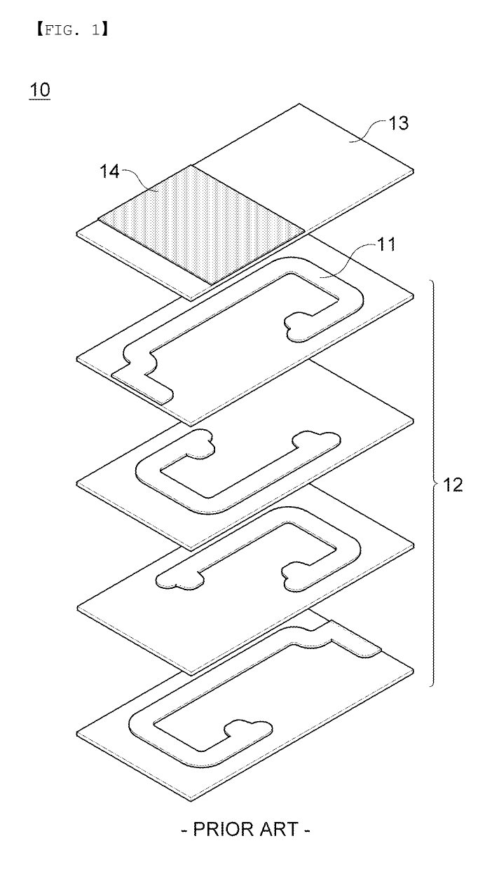

As described above, the inductor may be discriminated by primary strong color contrast and secondary depth difference between the discrimination via hole 121 and the sheet surfaces according to the thickness of the second sheet 120, whereby the inductor can be more easily discriminated than the case in which the inductor is discriminated by means of the marked portion 14 shown in FIG. 1.

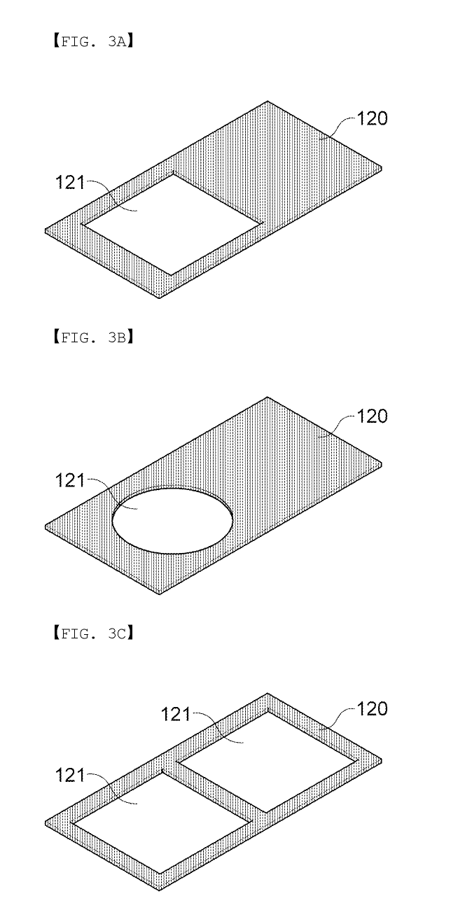

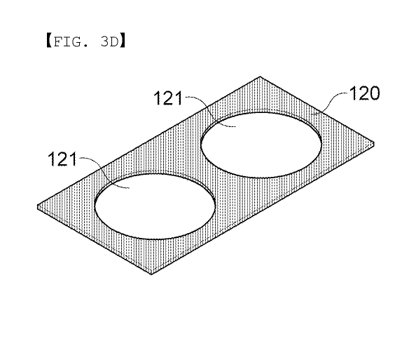

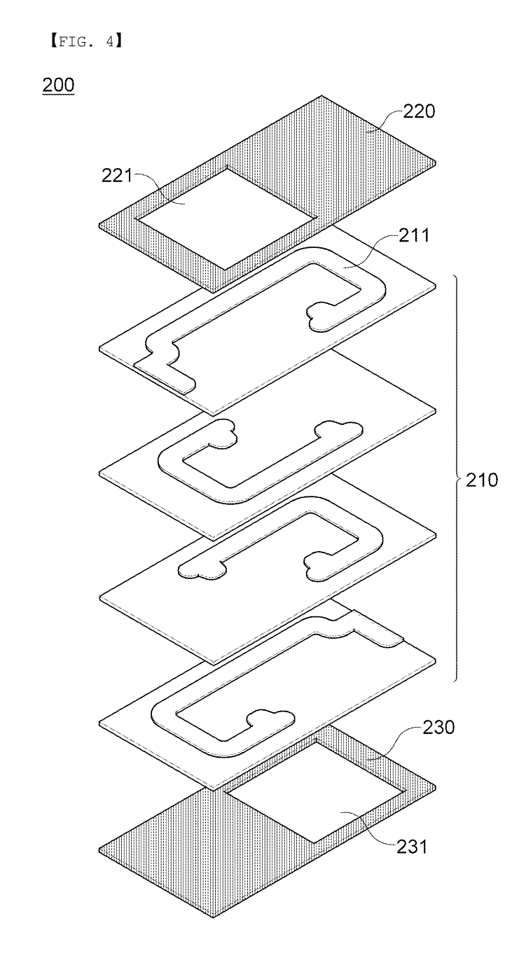

FIGS. 3A to 3D are illustrative views of modifying the second sheet 120 that is a component of the laminated chip inductor 100 according to the present invention into various shapes. According to characteristics and sorts of an inductor element, the second sheet 120 may have the discrimination via hole 121 having a circular shape as shown in FIG. 3A and have the discrimination via hole 121 having a square shape as shown in FIG. 3B. The inductor element has the circular shape and the square shape just by way of examples and it is apparent to those skilled in the art that the inductor element may have any shapes other than the circular shape and the square shape.

The number of the discrimination via hole 121 may be at least one, as shown in FIGS. 3C and 3D.

As described above, the via hole is configured to have various shapes and numbers, thereby making it possible to actively cope with diversification of elements and more improve the discrimination of elements.

FIG. 4 is a perspective view of a laminated chip inductor 200 in an exploded state according to another exemplary embodiment of the present invention.

With reference to FIG. 4, the laminated chip inductor 200 according to another exemplary embodiment of the present invention may include a laminate 210 including a plurality of first sheets having coil-shaped conductive patterns 211 printed thereon, a second sheet 220 provided on the laminate 210 and having a discrimination via hole 221 discriminating elements, and a third sheet 230 provided under the laminate 210 and having a discrimination via hole 231 discriminating elements.

Namely, unlike the laminated chip inductor 100 shown in FIG. 2, the laminated chip inductor 200 according to another exemplary embodiment of the present invention includes the second and third sheets 220 and 230 each having the discrimination via holes 221 and 231 each provided on and under the laminate 210, and particularly allows the discrimination via holes 221 and 231 each to be disposed at different axes of the upper surface and the bottom surface of the laminate 210, thereby making it possible to more facilitate discrimination of the elements.

Here, like the laminated chip inductor shown in FIG. 2, the third sheet 230 may be provided to be laminated simultaneously with laminating the plurality of first sheets and like the laminated chip inductor shown in FIG. 3, the discrimination via hole 231 may be configured to have the various number and shapes.

According to the exemplary embodiment of the present invention, the sheets including the via hole is provided, thereby making it possible to improve discrimination of the elements and not cause a problem in discriminating the elements even if a portion of edges is damaged by a polishing process and a cutting process.

A marking process for printing the marked portion is unnecessary, thereby making it possible to reducing costs of production.

A bending of a laminated chip inductor due to shrinkage error of the marked portion can be prevented.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

What is claimed is:

1. A chip inductor, comprising:
a laminate including a plurality of first sheets having conductive patterns printed thereon and laminated in order; and
a second sheet having a discrimination via hole and provided on or under the laminate.

2. The chip inductor according to claim 1, wherein a color of the second sheet is different from that of the laminate.

3. The chip inductor according to claim 1, wherein the second sheet is made of a different material from the laminate.

4. The chip inductor according to claim 1, wherein the discrimination via hole has a circular shape or a square shape.

5. The chip inductor according to claim 1, wherein the number of the discrimination via hole is at least one.

6. A chip inductor comprising:
a laminate having a plurality of first sheets printed with conductive patterns thereon and laminated in order;
a second sheet having a discrimination via hole and provided on the laminate; and
a third sheet having a discrimination via hole and provided under the laminate.

7. The chip inductor according to claim 6, wherein the second sheet and/or third sheet have different colors from the laminate.

8. The chip inductor according to claim 6, wherein the second sheet and/or the third sheet are made of a different material from the laminate.

9. The chip inductor according to claim 6, wherein the discrimination via hole has a circular shape and a square shape.

10. The chip inductor according to claim 6, wherein the number of the discrimination via hole is at least one.
